(19) United States
(12) Patent Application Publication
(10) Pub. No.: US 2006/0210192 A1
(43) Pub. Date: Sep. 21, 2006

(54) Automatic perspective distortion detection and correction for document imaging

(75) Inventor: Ufuk Orhun, Ottawa (CA)

Correspondence Address: PEARNE & GORDON LLP, 1801 EAST 9TH STREET, SUITE 1200, CLEVELAND, OH, 44114-3108, US

(73) Assignee: Symagery Microsystems Inc.

(21) Appl. No.: 11/082,588

(22) Filed: Mar. 17, 2005

(51) Int. Cl. G06K 9/40

(52) U.S. Cl. 382/275

(57) ABSTRACT

A method and apparatus for detecting and correcting perspective distortion for document imaging is described. The document template of the present invention contains special markers that define the corners of the document. One of these markers, different from the others, uniquely identifies a particular corner. When an image of a document is captured and it is found to contain perspective distortion, the smallest rectangle that encloses the special markers in the captured image is calculated and geometric transforms are used to map the special markers in the captured image to the corners of the smallest rectangle. To correct for orientation errors during image capture, the captured image is rotated based on the location of the unique marker. The present invention can also provide feedback to the operator as the image is being captured. This feedback guides the operator to properly align the image reader for substantially perspective distortion-free imaging.

### FIELD OF INVENTION

The present invention relates generally to the field of image readers, and more particularly to a method and apparatus for correcting perspective distortions and orientation errors.

### BACKGROUND OF THE INVENTION

The use of portable image readers over fixed-mount image readers is increasing and these portable image readers are seeing applications in many industries. One of the main challenges with portable image readers however is the perspective distortion caused by inconsistent image reading positions. With fixed-mount systems, such as a document scanner, the image reader is placed in such a manner that the optical path of the image reader is perpendicular to the image plane. With portable systems, however, the position of the image reader is dependent on a human operator. It is difficult for an operator to know the ideal point from where to capture an image of a target such as a document. More often than not, the user captures the image at an oblique angle, i.e. the image reader is not in a plane parallel to the plane of the document, and the captured image is skewed.

Accordingly, the image data may be uploaded to a personal computer for processing by various correction algorithms. The algorithms are employed to correct the distortion effects associated with off-angle images of documents. The correction algorithms require a user to manually identify the corners of a region of a captured image. Many image readers use geometric transforms such as affine transformations during post-processing of the image to correct for perspective distortions. In order to apply these transforms, the edges or corners of the image need to be defined. By measuring the spatial displacement of the identified corners from desired positions associated with a rectangular arrangement, an estimation of the amount of distortion is calculated. The correction algorithm then processes the imaged document to possess the desired perspective and size as necessary.

U.S. Patent Applications 2003/0156201—Zang published Aug. 21, 2003; 2004/0012679—Fan published Jan. 22, 2004 and 2004/0022451—Fugimoto published Feb. 5, 2004 discuss automatic methods for identifying the corner or edges of the document based on statistical models. While these methods do not require user input to manually identify the document corners, additional complexity is added to the image reader. Also, the degree of accuracy is not the same when the locations of the corners are estimated positions. A document can also contain many different types of objects such as 1 or 2-dimensional codes, text, written signatures, etc. As a result it may be difficult to define the boundaries of the document by statistical methods.

Further, the prior art accounts for correction of perspective distortion, but cannot correct for orientation. The operator may not always align the image reader in the same orientation as the document so the captured image may require rotation. Many image readers have rectangular aspect ratios so it is necessary at times to rotate the image reader by 90 degrees with respect to the document in order to “fill” the field of view (FOV) of the image reader with the document.

Therefore there is a need for an image reader that can automatically correct for both perspective distortion and orientation.

### SUMMARY OF THE INVENTION

The present invention is directed to a method and apparatus for correcting perspective distortion in an image captured by an image reader wherein the captured image has a number of special markers located on the boundary of the image having a predetermined shape. Distortion is corrected by calculating the smallest predetermined shape that encloses all of the special boundary markers, building a geometric transform to map the location of the special markers in the captured image to corresponding locations on the predetermined shape and applying the geometric transform to the captured image. Further, the special boundary markers may include a unique identifier marker different from the other special boundary markers, which is used to correct orientation errors in the captured image.

In accordance with a specific aspect of the invention, the predetermined shape of the image is a rectangle and the special boundary markers are corner markers. Further, the geometric transform comprises affine transformations.

The present invention is further directed to a method and apparatus for positioning an image reader having a rectangular field of view to avoid perspective distortion in a captured image wherein the captured image has special boundary markers located at the corners of the image having a rectangular shape. The image reader is positioned by capturing an image, calculating the distance between the special boundary markers and the field of view corners and determining if the distances are all the same within a predetermined tolerance. If the distances are not the same the image reader is repositioned by the operator and the image recaptured until the distances are all the same within the predetermined tolerance. Further, the special boundary markers may include a unique identifier marker different from the other special boundary markers, which is used to correct orientation errors in the captured image.

The invention is further directed to a method and apparatus for producing an image of a substantially rectangular target having special boundary markers at the corners with one of the markers being a unique corner marker. The image is produced by capturing an image using an image reader having a rectangular field of view, positioning the reader as a function of the distances from the markers to corners of the field of view and correcting orientation errors of the image using the unique corner marker. Orientation errors may be corrected by rotating the captured image. Further, perspective distortion may be corrected using the special boundary markers.

The present invention is also directed to a method and apparatus for producing an image of a substantially rectangular target having special boundary markers at the corners with one of the markers being a unique corner marker. The image is produced by capturing an image using an image reader, correcting perspective distortion on the captured image using the special boundary markers, correcting orientation errors of the image using the unique corner marker and processing the image. The perspective distortion may be corrected by calculating the smallest predetermined shape that encloses all of the special boundary markers, building a geometric transform to map the location of the special markers in the captured image to corresponding locations of the predetermined shape and applying the geometric transform to the captured image.

In accordance with another aspect of this invention, orientation errors in the image may be corrected by rotating the captured image.

In accordance with a specific aspect of this invention, the special boundary markers are polygon shapes.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a simplified diagram of an image reader;

FIG. 2 shows how perspective distortion is caused;

FIG. 3 shows the results of applying the present invention to an image with perspective distortion;

FIG. 4 is a flowchart outlining the process steps of a first embodiment of the present invention;

FIG. 5 shows an example of unique document markers;

FIG. 6 shows how the smallest rectangle is determined as part of the perspective distortion correction algorithm;

FIG. 7 is a flowchart outlining the process steps of a second embodiment of the present invention; and

FIG. 8 is a simplified diagram on an image reader employing the algorithms of the present invention.

### DETAILED DESCRIPTION

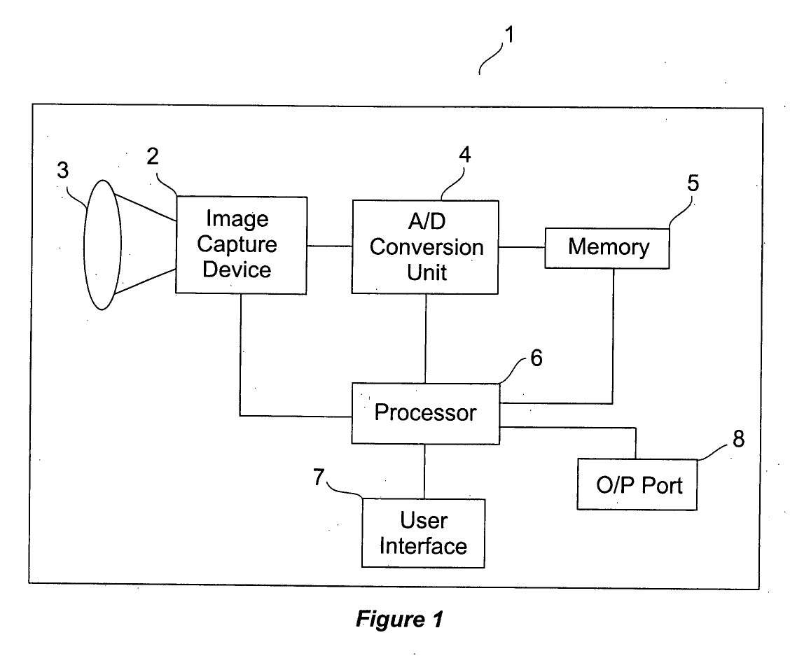

A conventional image reader, such as a portable image reader 1 is shown in the simplified diagram of FIG. 1. It comprises an image capture device 2, such as a CCD or CMOS image sensor, an optical system 3 mounted over the image sensor, an analog-to-digital A/D) conversion unit 4, memory 5, processor 6, user interface 7 and output port 8.

The analog information produced by image capture device 2 is converted to digital information by A/D conversion unit 4. A/D conversion unit 4 may convert the analog information received from image capture device 2 in either a serial or parallel manner. The converted digital information may be stored in memory 5 (e.g., random access memory or flash memory). The digital information is then processed by processor 6. Additionally or alternatively, other circuitry (not shown) may be utilized to process the captured image such as an application specific integrated circuit (ASIC). User interface 7 (e.g., a touch screen, keys, and/or the like) may be utilized to edit the captured and processed image. The image may then be provided to output port 8. For example, the user may cause the image to be downloaded to a personal computer (not shown) via output port 8.

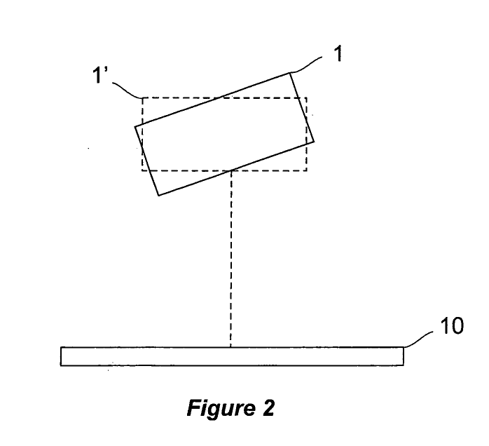

FIG. 2 shows diagrammatically how perspective distortion is caused. Image reader 1′ shown in dotted lines shows it in the correct position over a target 10 such as a document to ensure distortion-free imaging. In practice, the position of image reader 1 is as shown in solid lines. Image reader 1 is shown at an oblique angle with respect to document 10. Since the optical path of image reader 1 is not directly perpendicular with surface of document 10, perspective distortion will result.

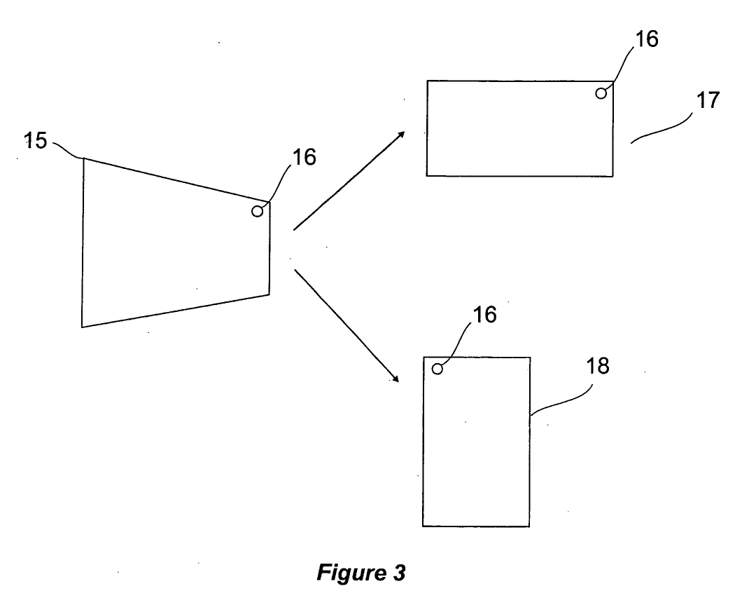

FIG. 3 shows the results of applying the method of the present invention to an image suffering from perspective distortion. Captured image 15 is a skewed image of a document. A marker 16 on the document indicates the location of the upper left hand corner of the document. In applying the present invention to captured image 15, the automatic perspective detection and correction method of the present invention produces a processed image 17. The distortion is removed from processed image 17, but marker 16, which indicates the upper left hand corner of the document, shows that processed image 17 is not oriented correctly. If perspective distortion correction and orientation correction are applied together, the result is processed image 18. Marker 16 of processed image 18 correctly indicates the upper left hand corner of the document, thus confirming correct orientation.

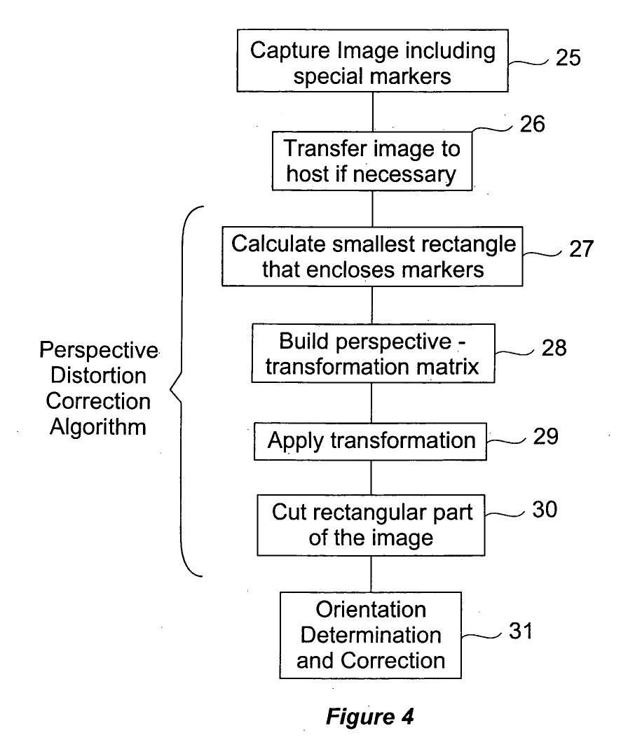

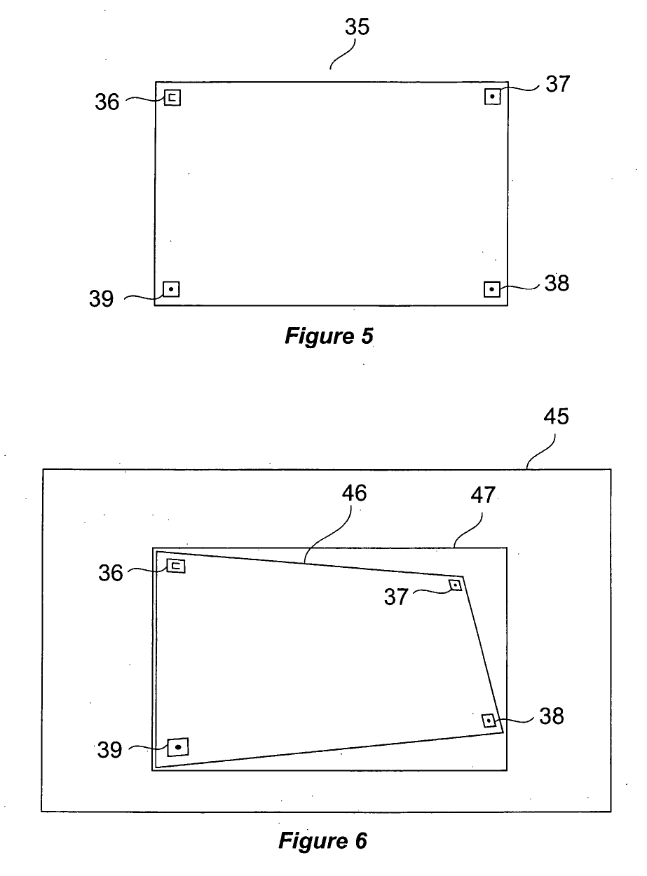

FIG. 4 shows a flowchart outlining a first embodiment of the present invention. The first step of the process is to capture 25 an image of the target such as a document 35 including special markers 36, 37, 38 and 39 as shown on FIG. 5. The special markers 36, 37, 38 and 39 are included on the document 35 to identify the four corners of the document boundary. Three markers 37, 38 and 39 out of the four markers 36, 37, 38 and 39 are identical, while a fourth marker 36 indicates a particular corner for example, the upper left hand corner. This is used as an orientation reference marker. The markers 36, 37, 38 and 39 in the present invention are polygon forms such as squares, circles or triangles. The markers 36, 37, 38 and 39 should be unique enough so that they are not confused with other objects on the document. A document template would include these special markers 36, 37, 38 and 39 and as a result all documents to be imaged will have the special markers. It should be understood by those skilled in the art that any number or shape of markers falls within the present invention.

FIG. 5 shows a specific example of a document template 35 having four special markers 36, 37, 38 and 39. Any targets that would need to be read such as one or two-dimensional codes, text or hand-written signatures would be transposed onto the document template and would be bounded by the four special markers 36, 37, 38 and 39. In the first embodiment of the present invention, the four special markers 36, 37, 38 and 39 define the boundary of the target in the document. These markers define the corners of a rectangle that encompasses the target. Those skilled in the art will realize that any number of markers forming any polygon defining the target may be implemented while still falling within the scope of the present invention. In FIG. 5, the four markers all include a square, but whereas markers 37, 38 and 39 all contain dots, marker 36 contains a three-line segment. This marker 36 uniquely identifies the upper left hand corner of document 35. If this document is captured by an image reader and marker 36 appears on the bottom left hand corner, it will be evident that a rotation is required to correct the orientation.

Referring to step 25 of FIG. 4 again, as the operator attempts to read an image, the image reader projects a targeting pattern onto the target image. This targeting pattern indicates to the operator either the center of, or the boundary of the image reader's FOV. The operator may need to move the image reader back and forth in front of the image so that the image reader can detect all of the special markers 36, 37, 38 and 39. Detection is done through pattern recognition software. The image reader will read all objects within its field of view until it identifies the special markers 36, 37, 38 and 39. Since these markers 36, 37, 38 and 39 are located along the periphery of the document, any object that appears similar to the markers, but is located in the center of the document, will be discarded. As soon as the image reader detects the four special markers 36, 37, 38 and 39, it will give feedback to the operator in the form of a visual indicator such as a light-emitting diode (LED) or an audible signal. Upon receiving the feedback, the operator can capture 25 the image. Since these markers 36, 37, 38 and 39 are necessary for the perspective distortion correction, the process cannot continue if they are not all detected. After image capture and special marker detection, the image and marker locations are transferred 26 to the host such as a personal computer for image processing. The image reader can also do the processing, if this capability is present.

Once it is established that all markers are present on the captured image, correction of the captured image begins. The first step of the perspective correction algorithm is to calculate 27 the smallest rectangle that encloses all the markers of the captured image. FIG. 6 shows a diagram of determining the smallest rectangle. Boundary 45 defines the FOV of the image reader as well as the boundary of the captured image. Document 46 located within boundary 45 suffers from perspective distortion. Markers 36, 37, 38 and 39 define the corners or boundaries of document 46. Based on the locations of these markers 36, 37, 38 and 39, the smallest rectangle that encloses them is defined by rectangle 47. The corrected image will have an area defined by rectangle 47.

The second step of the perspective correction algorithm is to build 28 a perspective transformation matrix that will map the markers of the captured image to the corresponding corners of the smallest rectangle. This requires the use of geometric transforms such as affine transformations. This technique is known to those skilled in the art and will not be discussed further here.

The third step of the perspective correction algorithm is to apply 29 the transformation, which will move the markers of the captured image to the corners of the smallest rectangle that encloses the captured image. The last step of the correction algorithm is to cut 30 the rectangular part of the image, the part of the image defined by the smallest rectangle, from the rest of the captured image. This rectangular image is then made the principal image. In reference to FIG. 6, the image defined by rectangle 47 is cut away from the image area defined by boundary 45. The image area defined by rectangle 47 becomes the principal image. This reduces the image size thus taking up less space in memory and making transmission of the image, such as to a host, much easier.

The final step in the process outlined in FIG. 4 is to determine 31 if rotation is required 31. This determination is based on the location of the upper left-hand corner marker 36, the orientation reference marker. The location of this marker 36 in any other corner other than the predetermined orientation reference corner marker, the upper left one, for example, indicates that rotation is required. The orientation reference marker is not limited to upper-left hand corner. Other corners can be envisioned while still falling within the scope of the present invention.

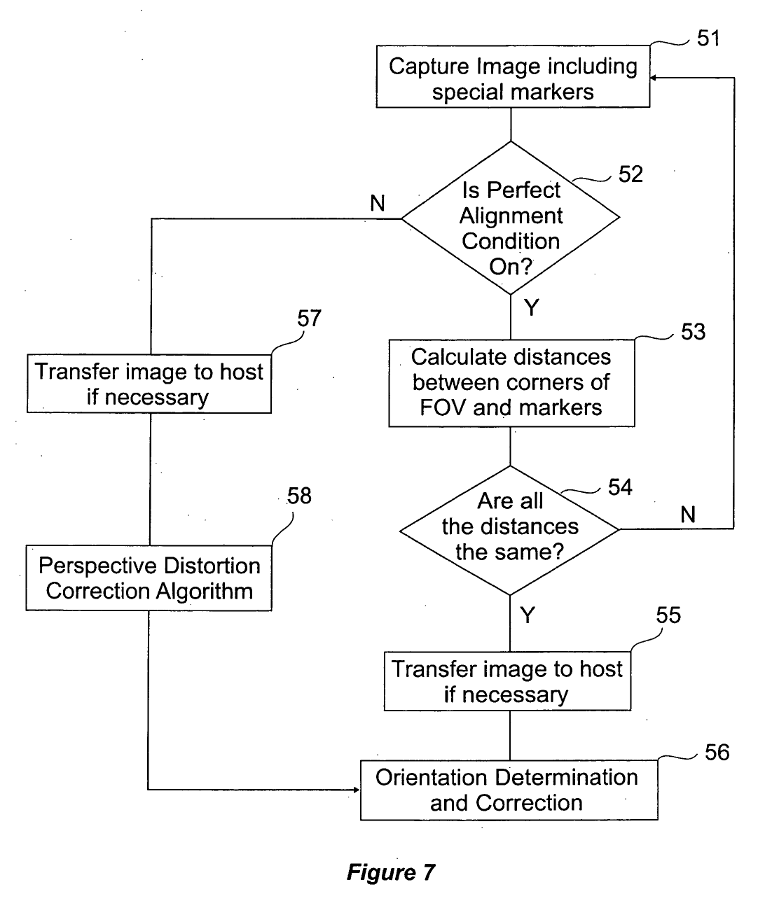

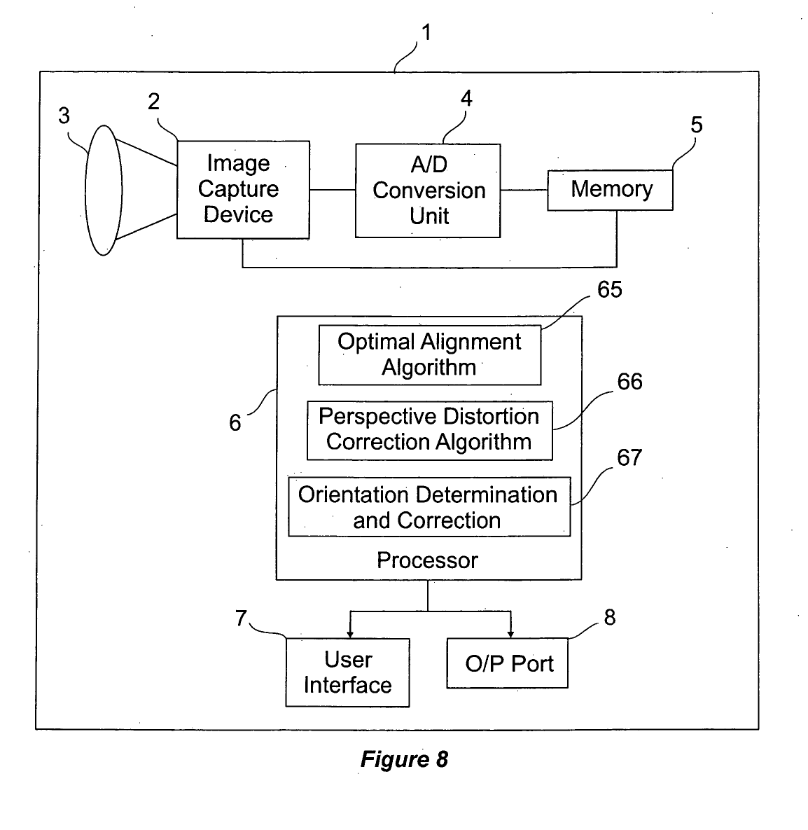

A further embodiment of the present invention incorporates perspective distortion detection that will reduce or may even eliminate the need for perspective distortion correction. This is done by determining a perfect alignment condition in which to capture the image. If the user can be guided as to how to correctly align the image reader over the target, perspective distortion in the resultant image can be avoided. FIG. 7 outlines the process for this embodiment of the present invention. The first step of capturing 51 the image including special markers 36, 37, 38 and 39 is similar to the first step of FIG. 4. Once all the special markers 36, 37, 38 and 39 are detected, feedback is given to the operator to capture 51 the image.

The next step of the process is to determine if the perfect alignment condition is switched on or enabled 52 in the image reader. If it is enabled, the next step 53 calculates the distance between the corners of the FOV 45 and the markers 36, 37, 38 and 39, i.e. the distance between the upper left hand corner of the FOV 45 and the upper left hand marker 36 and so on. Once the distances are measured for each of the four corners, the algorithm determines 54 if the distances between each marker and the corresponding FOV corner are all the same. If they are all the same, or within a predetermined tolerance to each other, the image is considered to be distortion free and the process continues to step 55. In this case, the image reader will provide “positive” feedback to the operator such as a LED indicator or an audible signal. If the distances are not all the same, the image reader will provide “negative” feedback, to indicate to the operator that distortion exists in the captured image and to re-capture the image. The algorithm then returns to step 51. This feedback is meant to guide the operator to manually correct the image reader alignment. This can be done through a number of ways such as left/right and/or top/bottom LED indicators. If the image reader needs to be moved in a particular direction, the appropriate LED will illuminate. Another option is the use of audible tones. As the operator moves the image reader, the tones can indicate if the operator is approaching proper alignment or increasing the amount of distortion.

Step 55 transfers the image to a host processor such as a personal computer for image processing. Step 55 is optional if the capability is present for the image reader itself to perform any post-processing.

The last step of this process is orientation determination and correction 56. Upon examination of the location of the orientation reference corner marker, the image may require rotation.

If it was determined that the perfect alignment condition was turned off or disabled in step 52, the image is transferred 57 to a host processor for image processing. This step is optional if the post-processing capability is present on the image reader. The next step is to correct 58 for perspective distortion by implementing the perspective distortion correction algorithm outlined in FIG. 4. Once the image has been corrected for distortion, the orientation determination and correction algorithm is applied 56.

It is also to be noted that it is within the present scope of this invention to correct 58 to correct the image for perspective distortion after step 55. This would be particularly desirable to correct for the minor perspective distortion permitted by the tolerances in step 54.

FIG. 8 shows the diagram of an image reader 1 of FIG. 1, but further including the algorithms of the present invention. Assuming that the captured image is not transferred to a host and the image reader 1 itself does the post-processing, the processor 6 of FIG. 8 includes the algorithms of the present invention. These include the optimal alignment algorithm 65 outlined in FIG. 7 and the perspective distortion correction algorithm 66 outlined in FIG. 4. If the optimal alignment condition is enabled, algorithm 65 is applied. If it is disabled, the perspective distortion correction algorithm 66 is applied.

From the embodiments described above, the present invention has the advantage of being simpler than the prior art by avoiding complex corner/edge detecting algorithms. The accuracy is also higher since the corners of the document are identifiable by the special markers, whereas the prior art uses statistical methods to provide an estimate of the document corners.

A further advantage of the present invention is the detection of perspective distortion, which gives feedback to the operator for correct positioning of the image reader. Perspective distortion correction may not be necessary if the operator can be guided into capturing a distortion-free image.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A method of correcting perspective distortion in an image captured by an image reader wherein the captured image has a number of special markers located on the boundary of the image having a predetermined shape, comprising the steps of:
a. calculating the smallest predetermined shape that encloses all of the special boundary markers;
b. building a geometric transform to map the location of the special markers in the captured image to corresponding locations on the predetermined shape; and
c. applying the geometric transform to the captured image.

2. The method as claimed in claim 1 wherein the special boundary markers include a unique identifier marker different from the other special boundary markers and the method comprises:
d. correcting for orientation errors in the captured image based on the unique marker identifier.

3. The method as claimed in claim 2 wherein step d. comprises rotating the captured image.

4. The method as claimed in claim 1 wherein the predetermined shape is a rectangle and the special boundary markers are corner markers.

5. The method as claimed in claim 1 wherein the special boundary markers are polygon shapes.

6. The method as claimed in claim 1 wherein the geometric transform comprises affine transformations.

7. The method as claimed in claim 1 wherein the method comprises:
e. cutting the image within the predetermined shape.

8. A method of positioning an image reader having a rectangular field of view to avoid perspective distortion in a captured image wherein the captured image has special boundary markers located at the corners of the image having a rectangular shape comprising the steps of:
a. capturing an image;
b. calculating the distance between the special boundary markers and the field of view corners;
c. determining if the distances are all the same within a predetermined tolerance; and
d. repositioning the image reader and recapturing the image if the distances are not the same within the predetermined tolerance;
e. repeating steps b., c. and d. until the distances are all the same within the predetermined tolerance.

9. The method as claimed in claim 8 wherein the special boundary markers include a unique identifier marker different from the other special boundary markers and the method comprises:
f. correcting for orientation errors in the captured image based on the unique marker identifier.

10. The method as claimed in claim 9 wherein the correcting for orientation errors step comprises rotating the captured image.

11. The method as claimed in claim 8 wherein the special boundary markers are polygon shapes.

12. A method of producing an image of a substantially rectangular target having special boundary markers at the corners with one of the markers being a unique corner marker using an image reader having a rectangular field of view comprising the steps of:
a. capturing an image;
b. positioning the reader as a function of the distances from the markers to corners of the field of view; and
c. correcting orientation errors of the image using the unique corner marker.

13. The method as claimed in claim 12 comprising before step c. correcting perspective distortion on the captured image using the special boundary markers.

14. The method as claimed in claim 12 wherein the correcting for orientation errors step comprises rotating the captured image.

15. The method as claimed in claim 12 wherein the special boundary markers are polygon shapes.

16. A method of producing an image of a substantially rectangular target having special boundary markers at the corners with one of the markers being a unique corner marker using an image reader comprising the steps of:
a. capturing an image;
b. correcting perspective distortion on the captured image using the special boundary markers; and
c. correcting orientation errors of the image using the unique corner marker.

17. The method as claimed in claim 16 wherein the correcting orientation errors step comprises rotating the captured image.

18. The method as claimed in claim 16 wherein the correcting perspective distortion step comprises the steps of:
b. 1. calculating the smallest predetermined shape that encloses all of the special boundary markers;
b.2 building a geometric transform to map the location of the special markers in the captured image to corresponding locations of the predetermined shape; and
b.3 applying the geometric transform to the captured image.

19. The method as claimed in claim 18 wherein the geometric transform comprises affine transformations.

20. The method as claimed in claim 16 wherein the special boundary markers are polygon shapes.

21. An apparatus for correcting perspective distortion in an image captured by an image reader wherein the captured image has a number of special markers located on the boundary of the image having a predetermined shape comprising:
means for calculating the smallest predetermined shape that encloses all of the special boundary markers;
means for building a geometric transform to map the location of the special markers in the captured image to corresponding locations of the predetermined shape; and
means for applying the geometric transform to the captured image.

22. The apparatus as claimed in claim 21 wherein the special boundary markers include a unique identifier marker different from the other special boundary markers and the apparatus comprises:
means for correcting for orientation errors in the captured image based on the unique marker identifier.

23. The apparatus as claimed in claim 22 wherein orientation correcting means comprises means for rotating the captured image.

24. The apparatus as claimed in claim 21 wherein the predetermined shape is a rectangle and the special boundary markers are corner markers.

25. The apparatus as claimed in claim 21 wherein the special boundary markers are polygon shapes.

26. The apparatus as claimed in claims 21 wherein the apparatus comprises:
means for cutting the image within the predetermined shape.

27. An apparatus for positioning an image reader having a rectangular field of view to avoid perspective distortion in a captured image wherein the captured image has special boundary markers located at the corners of the image having a rectangular shape comprising:
means for capturing an image;
means for calculating the distance between the special boundary markers and the field of view corners;
means for determining if the distances are all the same within a predetermined tolerance;
means for recapturing the image until the distances are all the same within a predetermined tolerance; and
means for indicating when the distances are all the same within a predetermined tolerance.

28. The apparatus as claimed in claim 27 wherein the special boundary markers include a unique identifier marker different from the other special boundary markers and the apparatus comprises means for correcting for orientation errors in the captured image based on the unique marker identifier.

29. The apparatus as claimed in claim 28 wherein the means for correcting orientation errors comprises means for rotating the captured image.

30. The apparatus as claimed in claim 27 wherein the special boundary markers are polygon shapes.

31. An apparatus for producing an image of a substantially rectangular target having special boundary markers at the corners with one of the markers being a unique corner marker using an image reader having a rectangular field of view comprising:
means for capturing an image;
means for providing an indication to position the reader as a function of the distances from the markers to corners of the field of view; and
means for correcting orientation errors of the image using the unique corner marker.

32. The apparatus as claimed in claim 31 comprising means for correcting perspective distortion on the captured image using the special boundary markers.

33. The apparatus as claimed in claim 31 wherein the means for correcting for orientation errors comprises means for rotating the captured image.

34. The apparatus as claimed in claim 31 wherein the special boundary markers are polygon shapes.

35. An apparatus for producing an image of a substantially rectangular target having special boundary markers at the corners with one of the markers being a unique corner marker using an image reader comprising the steps of:
means for capturing an image;
means for correcting perspective distortion on the captured image using the special boundary markers; and
means for correcting orientation errors of the captured image using the unique corner marker.

36. The apparatus as claimed in claim 35 wherein the means for correcting orientation errors comprises means for rotating the captured image.

37. The apparatus as claimed in 35 wherein the means for correcting perspective distortion comprises:
means for calculating the smallest predetermined shape that encloses all of the special boundary markers;
means for building a geometric transform to map the location of the special markers in the captured image to corresponding locations of the predetermined shape; and
means for applying the geometric transform to the captured image.

38. The apparatus as claimed in claim 37 wherein the geometric transform comprises affine transformations.

39. The apparatus as claimed in claim 35 wherein the special boundary markers are polygon shapes.
